(19) United States
(12) Patent Application Publication
(10) Pub. No.: US 2017/0018982 A1
(43) Pub. Date: Jan. 19, 2017

(54) ELECTRIC MOTOR FOR COMPRESSOR, COMPRESSOR, REFRIGERATING CYCLE APPARATUS, AND METHOD FOR MANUFACTURING ELECTRIC MOTOR FOR COMPRESSOR

(71) Applicants: Mitsubishi Electric Corporation, Tokyo (JP); Siam Compressor Industry Co., Ltd., Chonburi (TH)

(72) Inventors: Masashi ONO, Tokyo (JP); Takahiro TSUTSUMI, Tokyo (JP); Toshio ARAI, Tokyo (JP); Sadami OKUGAWA, Tokyo (JP); Taro KATO, Tokyo (JP); Suriwipha CHANLAKON, Chonburi (TH); Nuttagun JENWEERAWAT, Chonburi (TH)

(73) Assignees: Mitsubishi Electric Corporation, Tokyo (JP); Siam Compressor Industry Co., Ltd., Chonburi (TH)

(21) Appl. No.: 15/124,067

(22) PCT Filed: Apr. 20, 2015
(86) PCT No.: PCT/JP2015/061932

§ 371 Date: Sep. 7, 2016

(30) Foreign Application Priority Data
May 8, 2014 (JP) 2014-096885

(51) Int. Cl. H02K 3/04; F04C 29/00; H02K 15/00; H02K 3/32; H02K 15/10; H02K 15/08; F04C 23/00; F04C 18/356

(52) U.S. Cl. CPC H02K 3/04; F04C 23/008; F04C 29/0085; F04C 18/3562; H02K 3/32; H02K 15/105; H02K 15/08; H02K 15/0056; F04C 2210/26; F04C 2240/40

(57) ABSTRACT

An aluminum wire, which is an electric wire of an electric motor of a compressor, is wound around a copper wire, which is another electric wire, at interval in the length direction. The portion around which the aluminum wire is wound is brazed with a brazing material containing a flux. Thus, the aluminum wire and the copper wire are joined together, and an electric wire joint section is formed. Insulating paper is mounted to the electric wire joint section. The inner surface of the insulating paper is brought into contact with the surface of the electric wire joint section to which a residue of the flux adheres.

### TECHNICAL FIELD

The present invention relates to an electric motor (a motor) for a compressor, a compressor, a refrigerating cycle apparatus, and a method for manufacturing an electric motor for a compressor.

### BACKGROUND ART

Generally, as a method for joining electric wires (e.g., windings, or a winding and a lead wire) of an electric motor for a compressor, soldering or brazing is used.

In a case of using copper wires as the electric wires of the electric motor for a compressor, it is possible to join copper wires together by brazing using a copper-phosphorus brazing filler metal.

An aluminum wire less expensive than a copper wire may be used as an electric wire of the electric motor for a compressor. However, the melting point of aluminum is lower than the melting point of the copper-phosphorus brazing filler metal. Therefore, aluminum wires cannot be joined together or an aluminum wire and a copper wire cannot be joined together by brazing using the copper-phosphorus brazing filler metal.

Conventionally, there is a method for joining an aluminum wire and a copper wire together by soldering (e.g., refer to Patent Literature 1). In the conventional method, an aluminum wire and a copper wire are joined together, for example, in the following procedures.
(1) An aluminum wire is wound around a copper core wire of a lead wire.
(2) A portion around which the aluminum wire is wound is immersed in a flux tank for aluminum. Thus, the portion around which the aluminum wire is wound is coated with a flux for aluminum.
(3) The portion coated with the flux for aluminum is soldered by using solder for aluminum. Thus, the aluminum wire and the copper wire are joined together.
(4) The residue of the flux for aluminum is washed out.
(5) An insulating tube is fitted to the joint section of the aluminum wire and the copper wire, and the tube is contracted and is closely fitted to the joint section.

### CITATION LIST

### Patent Literature

Patent Literature 1: JP 2013-207964 A

### SUMMARY OF INVENTION

### Technical Problem

In the conventional method, many steps are required. For example, if the above-described step (2) can be omitted, work efficiency would be increased. In the above-described step (5), if it is possible to omit work to contract the insulating tube, work efficiency would be further increased.

Use of insulating paper (or an insulating sheet) which does not need to be contracted in lieu of the tube is considered. However, in the conventional method, since soldering for aluminum is applied to the portion coated with the flux and then the residue of the flux is washed out, the surface of the joint section (the soldered portion) of the aluminum wire and the copper wire becomes smooth. Therefore, if insulating paper is mounted to the joint section, when an electric motor is manufactured (e.g, when the joint section to which the insulating paper is mounted is buried among windings and fixed), the joint section slips out of the insulating paper, and there is a possibility that insulation failure occurs.

An object of the present invention is, for example, to prevent insulation failure of an electric motor for a compressor.

### Solution to Problem

An electric motor for a compressor according to one aspect of the present invention includes:

a plurality of electric wires joined together with a brazing material containing a flux, a joint portion of the plurality of electric wires having a surface to which a residue of the flux adheres; and

an insulating material to cover the joint portion of the plurality of electric wires, the insulating material having an inner surface brought into contact with the surface of the plurality of electric wires.

### Advantageous Effects of Invention

In the present invention, electric wires of an electric motor for a compressor are joined together with a brazing material containing a flux. The joint section of the electric wires is covered with an insulating material in a state in which a residue of the flux having large friction adheres to the surface of the joint section. Since the inner surface of the insulating material is brought into contact with the surface of the joint section, the joint section hardly slips off from the insulating material. Therefore, according to the present invention, it is possible to prevent insulation failure of the electric motor for a compressor.

### BRIEF DESCRIPTION OF DRAWINGS

FIG. 1 is a circuit diagram of a refrigerating cycle apparatus (during cooling) according to embodiments of the present invention.

FIG. 2 is a circuit diagram of the refrigerating cycle apparatus (during heating) according to the embodiments of the present invention.

FIG. 3 is a vertical cross-sectional view of a compressor according to the embodiments of the present invention.

FIG. 4 is a plan view of a stator of an electric motor according to the embodiments of the present invention.

FIG. 5 is a perspective view illustrating an electric wire joint section and insulating paper of an electric motor according to a first embodiment.

FIG. 6 is a side view of the electric wire joint section of the electric motor according to the first embodiment.

FIG. 7 is a side view of another electric wire joint section of the electric motor according to the first embodiment.

FIG. 8 is a flowchart illustrating procedures for joining and insulating electric wires of the electric motor according to the first embodiment.

FIG. 9 is a side view of an electric wire joint section of an electric motor according to a second embodiment.

FIG. 10 is a side view of an electric wire joint section of an electric motor according to a third embodiment.

FIG. 11 is a side view of an electric wire joint section of an electric motor according to a fourth embodiment.

### DESCRIPTION OF EMBODIMENTS

Hereinafter, embodiments of the present invention will be described with reference to drawings. Note that in the description of the embodiments, directions such as “upper”, “lower”, “left”, “right”, “front”, “rear”, “obverse”, and “reverse” are described as such for the sake of description, and not intended to limit the arrangement, orientation, and the like, of an apparatus, equipment, parts, and the like.

### First Embodiment

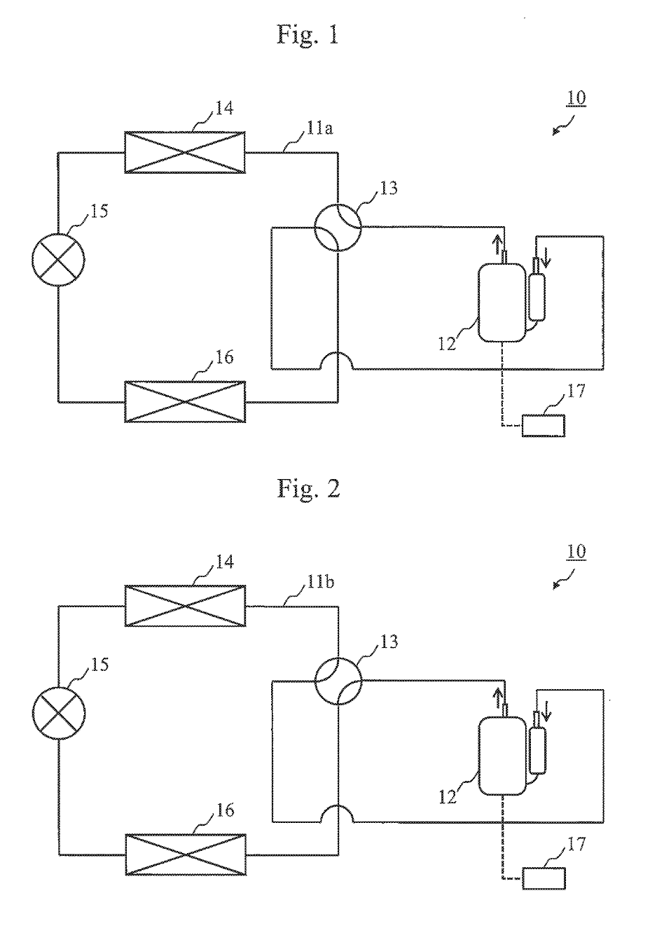

FIG. 1 and FIG. 2 are circuit diagrams of a refrigerating cycle apparatus 10 according to the present embodiment. FIG. 1 illustrates a refrigerant circuit 11a during cooling. FIG. 2 illustrates a refrigerant circuit 11b during heating.

In the present embodiment, the refrigerating cycle apparatus 10 is an air conditioner. Note that even if the refrigerating cycle apparatus 10 is an apparatus other than the air conditioner (e.g., a heat pump cycle apparatus), it is possible to apply the present embodiment thereto.

In FIG. 1 and FIG. 2, the refrigerating cycle apparatus 10 includes the refrigerant circuit 11a or 11b in which a refrigerant circulates.

A compressor 12, a four-way valve 13, an outdoor heat exchanger 14, an expansion valve 15, and an indoor heat exchanger 16 are connected to the refrigerant circuit 11a or 11b. The compressor 12 compresses the refrigerant. The four-way valve 13 changes the direction in which the refrigerant flows so that the direction during cooling differs from the direction during heating. The outdoor heat exchanger 14 is an example of a first heat exchanger. The outdoor heat exchanger 14 operates as a condenser during cooling, and radiates heat of the refrigerant compressed by the compressor 12. The outdoor heat exchanger 14 operates as an evaporator during heating, exchanges heat between outdoor air and the refrigerant expanded by the expansion valve 15, and heats the refrigerant. The expansion valve 15 is an example of an expansion mechanism. The expansion valve 15 expands the refrigerant the heat of which is radiated by the condenser. The indoor heat exchanger 16 is an example of a second heat exchanger. The indoor heat exchanger 16 operates as a condenser during heating, and radiates heat of the refrigerant compressed by the compressor 12. The indoor heat exchanger 16 operates as an evaporator during cooling, exchanges heat between indoor air and the refrigerant expanded by the expansion valve 15, and heats the refrigerant.

The refrigerating cycle apparatus 10 further includes a controlling device 17.

The controlling device 17 is, for example, a microcomputer. In the drawings, only connection between the controlling device 17 and the compressor 12 is illustrated; however, the controlling device 17 is connected not only to the compressor 12 but also to each element connected to the refrigerant circuit 11a or 11b. The controlling device 17 monitors and controls the state of each element.

As the refrigerant circulating in the refrigerant circuit 11a or 11b, an HFC (hydrofluorocarbon) refrigerant such as R32, R125, R134a, R407C, and R410A is used. Alternatively, an HFO (hydrofluoroolefin) refrigerant such as R1123, R1132(E), R1132(Z), R1132a, R1141, R1234yf, R1234ze(E), and R1234ze(Z) is used. Alternatively, a natural refrigerant such as R290 (propane), R600a (isobutane), R744 (carbon dioxide), R717 (ammonia) is used. Alternatively, another refrigerant is used. Alternatively, a mixture of two or more different refrigerants among the above refrigerants is used.

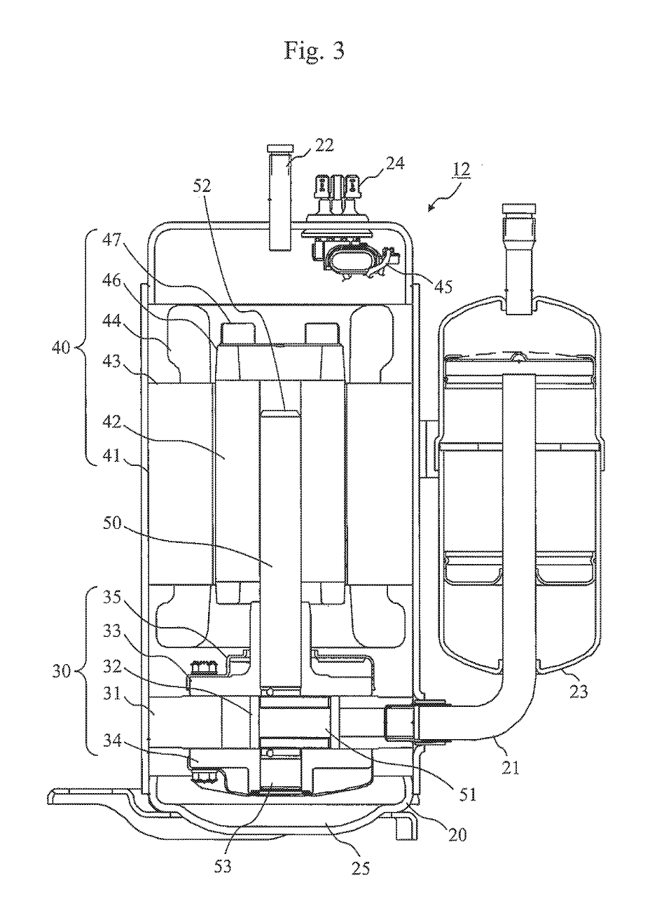

FIG. 3 is a vertical cross-sectional view of the compressor 12. Note that in FIG. 3, hatching indicating a cross section is omitted.

In the present embodiment, the compressor 12 is a single-cylinder rotary compressor. Note that even if the compressor 12 is a multi-cylinder rotary compressor, or a scroll compressor, it is possible to apply the present embodiment.

In FIG. 3, the compressor 12 includes a hermetic container 20, a compression element 30, an electric motor 40 (an electric motor for a compressor), and a crankshaft 50.

The hermetic container 20 is an example of a container. A suction pipe 21 for sucking the refrigerant and a discharge pipe 22 for discharging the refrigerant are attached to the hermetic container 20.

The compression element 30 is housed in the hermetic container 20. Specifically, the compression element 30 is disposed at a lower section inside the hermetic container 20. The compression element 30 compresses the refrigerant sucked into the suction pipe 21.

The electric motor 40 is also housed in the hermetic container 20. Specifically, the electric motor 40 is disposed at a position inside the hermetic container 20 where the refrigerant compressed by the compression element 30 passes before being discharged from the discharge pipe 22. That is, the electric motor 40 is disposed inside the hermetic container 20 and above the compression element 30. The electric motor 40 drives the compression element 30.

In the bottom section of the hermetic container 20, refrigerating machine oil 25 for lubricating a sliding section of the compression element 30 is reserved. As the refrigerating machine oil 25, for example, POE (polyol ester), PVE (polyvinyl ether), or AB (alkyl benzene), each of which is synthetic oil, is used.

Hereinafter, details of the compression element 30 will be described.

The compression element 30 includes a cylinder 31, a rolling piston 32, a vane (not illustrated), a main bearing 33, and an auxiliary bearing 34.

The outer circumference of the cylinder 31 has an approximately circular shape in plan view. Inside the cylinder 31, a cylinder chamber which is a space approximately circular in plan view is formed. Both axial ends of the cylinder 31 are open.

The cylinder 31 is provided with a vane groove (not illustrated) communicated with the cylinder chamber and extending in the radial direction. At the outside of the vane groove, a back pressure chamber which is a space approximately circular in plan view and communicated with the vane groove is formed.

The cylinder 31 is provided with a suction port (not illustrated) through which a gas refrigerant is sucked from the refrigerant circuit 11a or 11b. The suction port extends from the outer circumferential surface of the cylinder 31 to penetrate into the cylinder chamber.

The cylinder 31 is provided with a discharge port (not illustrated) through which the compressed refrigerant is discharged from the cylinder chamber. The discharge port is formed by notching the upper end surface of the cylinder 31.

The rolling piston 32 has a ring shape. The rolling piston 32 moves eccentrically in the cylinder chamber. The rolling piston 32 is slidably fitted to an eccentric shaft section 51 of the crankshaft 50.

The shape of the vane is a flat and approximately rectangular parallelepiped shape. The vane is disposed in the vane groove of the cylinder 31. The vane is constantly pressed against the rolling piston 32 by a vane spring (not illustrated) provided in the back pressure chamber. Since the pressure inside the hermetic container 20 is high, a force generated due to a difference between the pressure inside the hermetic container 20 and the pressure in the cylinder chamber acts on the back surface (i.e., the surface on the back pressure chamber side) of the vane when the operation of the compressor 12 is started. Therefore, the vane spring is used for the purpose of pressing the vane against the rolling piston 32 mainly at startup of the compressor 12 (when there is no difference between the pressure in the hermetic container 20 and the pressure in the cylinder chamber).

The main bearing 33 has an approximately inverse T shape in side view. The main bearing 33 is slidably fitted to a main shaft section 52, which is a portion upper than the eccentric shaft section 51, of the crankshaft 50. The main bearing 33 closes the upper sides of the cylinder chamber and the vane groove of the cylinder 31.

The auxiliary bearing 34 has an approximately T shape in side view. The auxiliary bearing 34 is slidably fitted to an auxiliary shaft section 53, which is a portion lower than the eccentric shaft section 51, of the crankshaft 50. The auxiliary bearing 34 closes the lower sides of the cylinder chamber and the vane groove of the cylinder 31.

The main bearing 33 includes a discharge valve (not illustrated). A discharge muffler 35 is attached to the outside of the main bearing 33. A high-temperature and high-pressure gas refrigerant discharged via the discharge valve once enters the discharge muffler 35 and then is emitted to a space in the hermetic contain 20 from the discharge muffler 35. Note that the discharge valve and the discharge muffler 35 may be provided on the auxiliary bearing 34 or on both the main bearing 33 and the auxiliary bearing 34.

The material of the cylinder 31, the main bearing 33, and the auxiliary bearing 34 is gray cast iron, sintered steel, carbon steel, or the like. The material of the rolling piston 32 is, for example, alloy steel containing chromium or the like. The material of the vane is, for example, high-speed tool steel.

A suction muffler 23 is provided beside the hermetic container 20. The suction muffler 23 sucks a low-pressure gas refrigerant from the refrigerant circuit 11a or 11b. In a case in which a liquid refrigerant is returned, the suction muffler 23 prevents the liquid refrigerant from directly entering the cylinder chamber of the cylinder 31. The suction muffler 23 is connected to the suction port of the cylinder 31 via the suction pipe 21. The body of the suction muffler 23 is fixed to a side surface of the hermetic container 20 by welding or the like.

Hereinafter, details of the electric motor 40 will be described.

In the present embodiment, the electric motor 40 is an induction electric motor. Note that it is possible to apply the present embodiment even if the electric 40 is a motor other than the induction electric motor, such as a brushless DC (direct current) motor.

The electric motor 40 includes a stator 41 and a rotor 42.

The stator 41 is fixed in contact with the inner circumferential surface of the hermetic container 20. The rotor 42 is disposed inside the stator 41 with a gap of about 0.3 to 1 mm therebetween.

The stator 41 includes a stator iron core 43 and a winding section 44. The stator iron core 43 is manufactured by punching magnetic steel sheets each of which has a thickness of 0.1 to 1.5 mm into a predetermined shape, laminating the punched sheets in the axial direction, and fixing the sheets by caulking, welding, or the like. The winding section 44 is configured by winding windings around a plurality of teeth (not illustrated) formed on the stator iron core 43. Lead wires 45 are connected to the winding section 44.

A plurality of notches is formed at approximately equal intervals in the circumferential direction on the outer circumference of the stator iron core 43. Each notch serves as one of the paths for the gas refrigerant emitted from the discharge muffler 35 to the space in the hermetic container 20. Each notch also serves as a path for the refrigerating machine oil 25 returning from above the electric motor 40 to the bottom section of the hermetic container 20.

The rotor 42 is a squirrel-cage rotor made by aluminum die casting. The rotor 42 includes a rotor iron core 46, conductors (not illustrated), and end rings 47. Similarly to the stator iron core 43, the rotor iron core 46 is manufactured by punching magnetic steel sheets each of which has a thickness of 0.1 to 1.5 mm into a predetermined shape, laminating the punched sheets in the axial direction, and fixing the sheets by caulking, welding, or the like. The conductors are made of aluminum. The conductors are filled or inserted in a plurality of slots formed on the rotor iron core 46. The end rings 47 short-circuit both ends of the conductors. Thus, a squirrel-cage winding is formed.

A plurality of through holes penetrating in an approximately axial direction is formed in the rotor iron core 46. Similarly to the notches on the stator iron core 43, each through hole serves as one of the paths for the gas refrigerant emitted from the discharge muffler 35 to the space in the hermetic container 20.

Note that in a case (not illustrated) in which the electric motor 40 is configured as a brushless DC motor, permanent magnets are inserted in each of insertion holes formed on the rotor iron core 46. As each permanent magnet, for example, a ferrite magnet or a rare-earth magnet is used. In order to prevent the permanent magnets from slipping off in the axial direction, an upper end plate and a lower end plate are provided at the upper end and the lower end (i.e., both axial ends) of the rotor 42, respectively. The upper end plate and the lower end plate also serve as a rotation balancer. The upper end plate and the lower end plate are fixed to the rotor iron core 46 by means of a plurality of fixing rivets or the like.

A terminal 24 (e.g., a glass terminal) connected to an external power supply is attached to the top section of the hermetic container 20. The terminal 24 is fixed to the hermetic container 20, for example, by welding. The lead wires 45 from the electric motor 40 are connected to the terminal 24.

The discharge pipe 22 whose both axial ends are open is attached to the top section of the hermetic container 20. The gas refrigerant discharged from the compression element 30 passes from the space in the hermetic container 20 through the discharge pipe 22, and is discharged to the external refrigerant circuit 11a or 11b.

Hereinafter, the operation of the compressor 12 will be described.

Power is supplied from the terminal 24 to the stator 41 of the electric motor 40 via the lead wires 45. Thus, the rotor 42 of the electric motor 40 rotates. Due to the rotation of the rotor 42, the crankshaft 50 fixed to the rotor 42 rotates. In association with the rotation of the crankshaft 50, the rolling piston 32 of the compression element 30 eccentrically rotates in the cylinder chamber of the cylinder 31 of the compression element 30. The space between the cylinder 31 and the rolling piston 32 is divided into two by the vane of the compression element 30. In association with the rotation of the crankshaft 50, the volumes of the two spaces change. In one of the spaces, the refrigerant is sucked from the suction muffler 23 due to a gradual increase in volume of the space. In the other space, the gas refrigerant inside is compressed due to a gradual decrease in volume of the space. The compressed gas refrigerant is discharged once from the discharge muffler 35 to the space in the hermetic container 20. The discharged gas refrigerant passes through the electric motor 40 and is discharged outside the hermetic container 20 through the discharge pipe 22 disposed at the top section of the hermetic container 20.

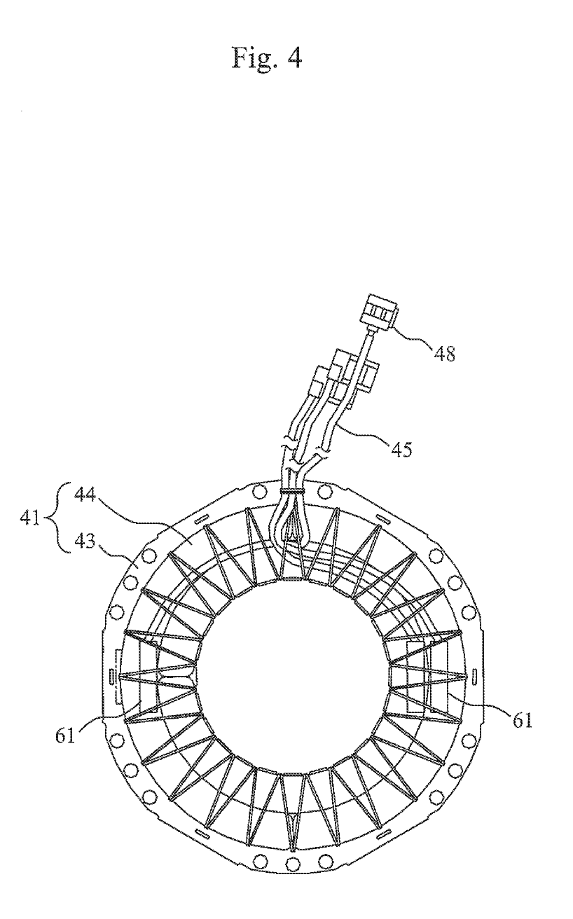

FIG. 4 is a plan view of the stator 41 of the electric motor 40.

In FIG. 4, as described above, the stator 41 includes the stator iron core 43 and the winding section 44. Three lead wires 45 are connected to the winding section 44. Each lead wire 45 is used for connecting one or more windings of the winding section 44 and the terminal 24 attached to the hermetic container 20.

One end of each lead wire 45 is a connector 48 inserted in and connected to the terminal 24. The other end of each lead wire 45 is joined to the windings of the winding section 44. Insulating paper 61 is mounted to the joint sections of the lead wires 45 and the windings. Although not illustrated in FIG. 4, the joint sections to which the insulating paper 61 is mounted are buried among the windings and fixed.

In the present embodiment, as a means to insulate the joint sections of the lead wires 45 and the windings, not tubes but the insulating paper 61 is used. Therefore, work to contract the tubes and closely fit the tubes to the joint section is not necessary, and work efficiency is improved.

In the present embodiment, the insulating paper 61 is used not only for spots where the lead wires 45 and the windings are joined together but also for spot where the windings are joined together (e.g., a neutral point).

The material of the insulating paper 61 is, for example, PET (polyethylene terephthalate).

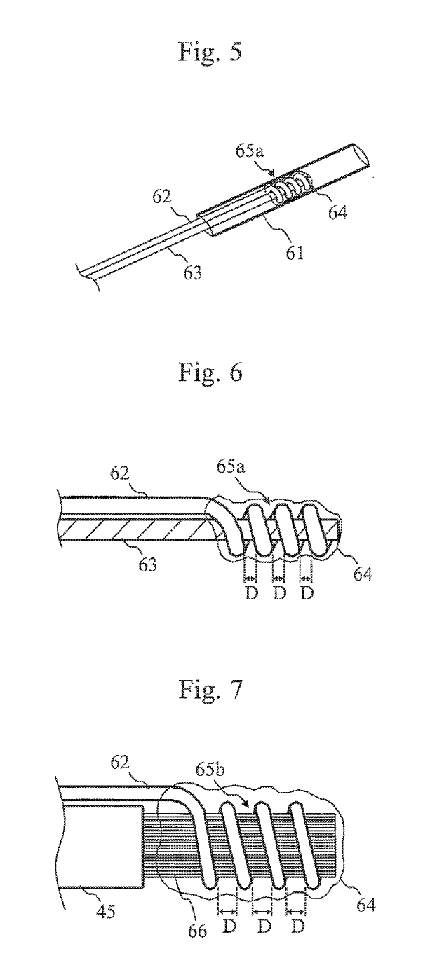

FIG. 5 is a perspective view illustrating an electric wire joint section 65a and the insulating paper 61 of the electric motor 40.

In FIG. 5, an aluminum wire 62, which is part of the windings of the winding section 44, and a copper wire 63 (a solid wire), which is other part of the windings of the winding section 44, are joined together with a brazing material 64 containing a flux. The aluminum wire 62 and the copper wire 63 are examples of a plurality of electric wires that the electric motor 40 includes. Since the flux is contained in the brazing material 64, a residue of the flux adheres to the surface of the electric wire joint 65a, which is a portion at which the aluminum wire 62 and the copper wire 63 are joined. Therefore, the surface of the electric wire joint section 65a is not smooth but rough.

The insulating paper 61 is mounted to the electric wire joint section 65a so as to cover the electric wire joint section 65a. The insulating paper 61 is an example of an insulating material that the electric motor 40 includes. The inner surface of the insulating paper 61 is brought into contact with the surface of the electric wire joint section 65a. Since the surface of the electric wire joint section 65a is rough, a friction force acts on the surfaces of the insulating paper 61 and the electric wire joint section 65a in contact with each other. Therefore, the electric wire joint section 65a hardly slips off from the insulating paper 61. That is, according to the present embodiment, it is possible to prevent insulation failure of the electric motor 40. Note that in the present embodiment, in lieu of the insulating paper 61, a different insulating material such as an insulating sheet may be used.

The electric wire joint section 65a and the insulating paper 61 may also be fixed together with varnish. Thus, the electric wire joint section 65a more hardly slips off from the insulating paper 61.

FIG. 6 is a side view of the electric wire joint section 65a of the electric motor 40.

In FIG. 6, the aluminum wire 62 is wound around the copper wire 63 at interval D in the length direction. The portion around which the aluminum wire 62 is wound is brazed with the brazing material 64. Thus, the electric wire joint section 65a is formed. It is desirable that the width of the interval D be constant (e.g., about 2 mm) from the winding start to the winding end of the aluminum wire 62. In the present embodiment, since the brazing material 64 infiltrates into the interval D, the joint state between the aluminum wire 62 and the copper wire 63 is good.

The portion corresponding to the aluminum wire 62 in the brazing filler metal of the brazing material 64 forming the electric wire joint section 65a bulges and the portion corresponding to the interval D in the brazing filler metal is recessed. The flux contained in the brazing material 64 tends to remain in the recessed portion. Therefore, even if part of the flux disappears during brazing work, the residue of the flux adheres to at least a position corresponding to the interval D on the surface of the electric wire joint section 65a. Thus, it is possible to surely make the surface of the electric wire joint section 65a rough.

As the brazing material 64, it is necessary to use a material whose melting point is sufficiently lower than the melting point of the base material. Therefore, in the present embodiment, it is preferable that a material whose melting point is lower by 150° C. or more than both the melting point of the aluminum wire 62 and the melting point of the copper wire 63 be used as the brazing material 64.

In addition, as the brazing material 64, it is necessary to use a material whose melting point is sufficiently higher than the temperature inside the hermetic container 20 of the compressor 12. Therefore, in the present embodiment, it is preferable to use as the brazing material 64 a material whose melting point is 400° C. or higher.

As a brazing filler metal whose melting point is lower by 150° C. or more than both the melting point of the aluminum wire 62 and the melting point of the copper wire 63 and whose melting point is 400° C. or higher, a Zn—Al based brazing filler metal may be used, for example. Note that as the brazing filler metal of the brazing material 64, a brazing filler metal other than the Zn—Al based brazing filler metal may be used.

As a flux contained in the brazing material 64, cesium fluoride, a mixture of aluminum fluoride and cesium fluoride, or the like may be used.

FIG. 7 is a side view of an electric wire joint section 65b of the electric motor 40.

In FIG. 7, the aluminum wire 62, which is part of the windings of the winding section 44, is wound around a copper core wire 66 (a stranded wire) of a lead 45 at interval D in the length direction. The portion around which the aluminum wire 62 is wound is brazed with the brazing material 64. Thus, the aluminum wire 62 and the lead wire 45 are joined together to form the electric wire joint section 65b. The aluminum wire 62 and the lead wire 45 are examples of the plurality of electric wires that the electric motor 40 includes. The brazing material 64 is the same as the brazing material 64 illustrated in FIG. 5 and FIG. 6. Since the flux is contained in the brazing material 64, a residue of the flux adheres to the surface of the electric wire joint section 65b. Therefore, the surface of the electric wire joint section 65b is not smooth but rough. The interval D is the same as the interval D illustrated in FIG. 6.

Although not illustrated, the electric wire joint section 65b is covered with the insulating paper 61 in the same manner as the electric wire joint section 65a illustrated in FIG. 5. The inner surface of the insulating paper 61 is brought into contact with the surface of the electric wire joint section 65b. Since the surface of the electric wire joint section 65b is rough, a friction force acts on the surfaces of the insulating paper 61 and the electric wire joint section 65b in contact with each other. Therefore, the electric wire joint section 65b hardly slips off from the insulating paper 61.

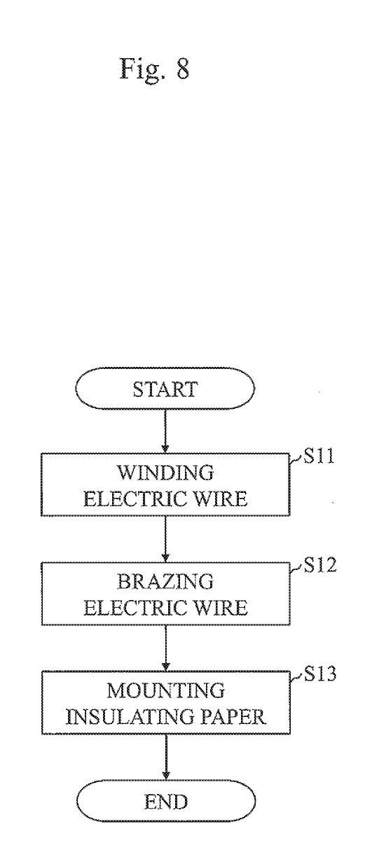

FIG. 8 is a flowchart illustrating procedures for joining and insulating electric wires of the electric motor 40 (steps included in a method for manufacturing the electric motor 40 according to the present embodiment).

In S11 in FIG. 8, one electric wire (e.g., the aluminum wire 62) is wound around one or more other electric wires (e.g., the copper wire 63 or the copper core wire 66 of the lead wire 45) at interval D in the length direction.

In S12 in FIG. 8, a portion around which the one electric wire is wound is brazed with the brazing material 64 containing the flux. Thus, the plurality of electric wires is joined together.

In S13 in FIG. 8, the insulating paper 61 is mounted to the portion at which the plurality of electric wires is joined together, and the inner surface of the insulating paper 61 is brought into contact with the surface of the portion at which the plurality of electric wires is joined together, to which the residue of the flux adheres.

In the present embodiment, the flux is contained in the brazing material 64. Therefore, it is not necessary to immerse the portion around which the one electric wire is wound in a flux tank before brazing (S12), and work efficiency is improved.

In addition, in the present embodiment, since the portion at which the plurality of electric wires is joined together is made to hardly slip off from the insulating paper 61 by using the residue of the flux which adheres to the surface of that portion, the work for washing out the flux is unnecessary.

As described above, in the present embodiment, the electric motor 40 has a wire connection spot where a plurality of electric wires (e.g., the aluminum wire 62, the copper wire 63, and the copper core wire 66 of the lead wire 45) is joined together with the brazing material 64. The wire connection spot is covered with the insulating paper 61 at least one end of which is open, and is fixed in contact with a charging section of the windings or the like. At the wire connection spot, one electric wire is spirally wound around one or more other electric wires, and these electric wires are joined with the brazing material 64 containing the flux, whose melting point is lower by 150° C. or more than any melting points of the electric wires. Therefore, it is possible to join the spirally wound electric wire without melting the electric wire. A flux residue component having large friction adheres to the surface of the joint section, and therefore it is possible to obtain a state in which the insulating paper 61 hardly slips. Thus, it is possible to avoid a situation in which the insulating paper 61 slips and the joint section is exposed. Therefore, it is possible to obtain the compressor 12 which is free from insulation failure and highly reliable.

In the electric motor 40 of the compressor 12, the temperature of the windings may instantly rise to about 200° C. However, in the present embodiment, it is possible to prevent melting of the joint section by using the brazing material 64 containing the flux, whose melting point is 400 degrees or higher.

Aluminum is softer than copper. In the present embodiment, when joining the aluminum wire 62 and one or more other electric wires, the aluminum wire 62 is spirally wound around the other electric wires. Thus, winding workability is improved. In addition, since it is possible to make the surface area of the aluminum wire 62 in the joint section large, an oxide film on the surface of the aluminum wire 62 is removed by the activated flux, and therefore the brazing filler metal whose flowability is improved easily infiltrates into the entirety of the joint section.

### Second Embodiment

The present embodiment be described mainly focusing on points of difference from the first embodiment.

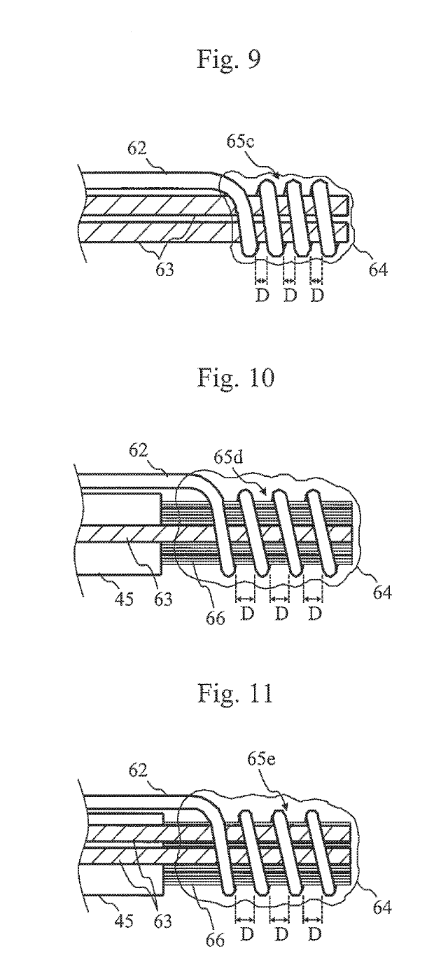

FIG. 9 is a side view of an electric wire joint section 65c of an electric motor 40.

In FIG. 9, an aluminum wire 62, which is part of the windings of a winding section 44, is wound around two copper wires 63 (solid wires), which are other part of the windings of the winding section 44 and are parallel to each other, at interval D in the length direction. The portion around which the aluminum wire 62 is wound is brazed with a brazing material 64. Thus, the aluminum wire 62 and the two copper wires 63 are joined together to form the electric wire joint section 65c. The aluminum wire 62 and the two copper wires 63 are examples of a plurality of electric wires that the electric motor 40 includes. The brazing material 64 is the same as the brazing material 64 in the first embodiment illustrated in FIG. 5 and FIG. 6. Since a flux is contained in the brazing material 64, a residue of the flux adheres to the surface of the electric wire joint section 65c. Therefore, the surface of the electric wire joint section 65c is not smooth but rough. The interval D is the same as the interval D in the first embodiment illustrated in FIG. 6. Note that the number of copper wires 63 may be greater than two.

Although not illustrated, the electric wire joint section 65c is covered with insulating paper 61 in the same manner as the electric wire joint section 65a illustrated in FIG. 5. The inner surface of the insulating paper 61 is brought into contact with the surface of the electric wire joint section 65c. Since the surface of the electric wire joint section 65c is rough, a friction force acts on the surfaces of the insulating paper 61 and the electric wire joint section 65c in contact with each other. Therefore, the electric wire joint section 65c hardly slips off from the insulating paper 61.

According to the present embodiment, the same effects as the effects of the first embodiment are obtained. For example, it is possible to prevent insulation failure of the electric motor 40.

### Third Embodiment

The present embodiment will be described mainly focusing on points of difference from the first embodiment.

FIG. 10 is a side view of an electric wire joint section 65d of an electric motor 40.

In FIG. 10, an aluminum wire 62, which is part of the windings of a winding section 44, is wound around one copper wire 63 (a solid wire), which is other part of the windings of the winding section 44, and a copper core wire 66 (a stranded wire) of a lead wire 45, which is parallel to the copper wire 63, at interval D in the length direction. The portion around which the aluminum wire 62 is wound is brazed with a brazing material 64. Thus, the aluminum wire 62, the copper wire 63, and the lead wire 45 are joined together to form the electric wire joint section 65d. The aluminum 62, the copper wire 63, and the lead wire 45 are examples of a plurality of electric wires that the electric motor 40 includes. The brazing material 64 is the same as the brazing material 64 in the first embodiment illustrated in FIG. 5 and FIG. 6. Since a flux is contained in the brazing material 64, a residue of the flux adheres to the surface of the electric wire joint section 65d. Therefore, the surface of the electric wire joint section 65d is not smooth but rough. The interval D is the same as the interval D in the first embodiment illustrated in FIG. 6.

Although not illustrated, the electric wire joint section 65d is covered with insulating paper 61 in the same manner as the electric wire joint section 65a illustrated in FIG. 5. The inner surface of the insulating paper 61 is brought into contact with the surface of the electric wire joint section 65d. Since the surface of the electric wire joint section 65d is rough, a friction force acts on the surfaces of the insulating paper 61 and the electric wire joint section 65d in contact with each other. Therefore, the electric wire joint section 65d hardly slips off from the insulating paper 61.

According to the present embodiment, the same effects as the effects of the first embodiment are obtained. For example, it is possible to prevent insulation failure of the electric motor 40.

### Fourth Embodiment

The present embodiment will be described mainly focusing on points of difference from the first embodiment.

FIG. 11 is a side view of an electric wire joint section 65e of an electric motor 40.

In FIG. 11, an aluminum wire 62, which is part of the windings of a winding section 44, is wound around two copper wires 63 (solid wires), which are other part of the windings of the winding section 44 and are parallel to each other, and a copper core wire 66 (a stranded wire) of a lead wire 45, which is parallel to the copper wires 63, at interval D in the length direction. The portion around which the aluminum wire 62 is wound is brazed with a brazing material 64. Thus, the aluminum wire 62, the two copper wires 63, and the lead wire 45 are joined together to form the electric wire joint section 65e. The aluminum wire 62, the two copper wires 63, and the lead wire 45 are examples of a plurality of electric wires that the electric motor 40 includes. The brazing material 64 is the same as the brazing material 64 in the first embodiment illustrated in FIG. 5 and FIG. 6. Since a flux is contained in the brazing material 64, a residue of the flux adheres to the surface of the electric wire joint section 65e. Therefore, the surface of the electric wire joint section 65e is not smooth but rough. The interval D is the same as the interval D in the first embodiment illustrated in FIG. 6. Note that the number of copper wires 63 may be greater than two.

Although not illustrated, the electric wire joint section 65e is covered with insulating paper 61 in the same manner as the electric wire joint section 65a illustrated in FIG. 5. The inner surface of the insulating paper 61 is brought into contact with the surface of the electric wire joint section 65e. Since the surface of the electric wire joint section 65e is rough, a friction force acts on the surfaces of the insulating paper 61 and the electric wire joint section 65e in contact with each other. Therefore, the electric wire joint section 65e hardly slips off from the insulating paper 61.

According to the present embodiment, the same effects as the effects of the first embodiment are obtained. For example, it is possible to prevent insulation failure of the electric motor 40.

Embodiments of the present invention have been described above; however, some of the embodiments may be implemented in combination. Alternatively, any one or some of the embodiments may be implemented in part. For example, any one of or an arbitrary combination of some of what are described as “sections” in the description of the embodiments may be adopted. Note that the present invention is not limited to the embodiments, and various modifications may be made as necessary.

### REFERENCE SIGNS LIST

10: refrigerating cycle apparatus, 11a, 11b: refrigerant circuit, 12: compressor, 13: four-way valve, 14: outdoor heat exchanger, 15: expansion valve, 16: indoor heat exchanger, 17: controlling device, 20: hermetic container, 21: suction pipe, 22: discharge pipe, 23: suction muffler, 24: terminal, 25: refrigerating machine oil, 30: compression element, 31: cylinder, 32: rolling piston, 33: main bearing, 34: auxiliary bearing, 35: discharge muffler, 40: electric motor, 41: stator, 42: rotor, 43: stator iron core, 44: winding section, 45: lead wire, 46: rotor iron core, 47: end ring, 48: connector, 50: crankshaft, 51: eccentric shaft section, 52: main shaft section, 53: auxiliary shaft section, 61: insulating paper, 62: aluminum wire, 63: copper wire, 64: brazing material, 65a, 65b, 65c, 65d, 65e: electric wire joint section, and 66: copper core wire

1. An electric motor for a compressor comprising:
a plurality of electric wires including an aluminum wire, the plurality of electric wires being joined together with a brazing material containing a flux, a joint portion of the plurality of electric wires having a surface of the brazing material to which a residue of the flux adheres; and
an insulating material to cover the joint portion of the plurality of electric wires, the insulating material having an inner surface brought into contact with the surface of the brazing material in the joint portion of the plurality of electric wires.

2. The electric motor for a compressor according to claim 1, wherein one electric wire of the plurality of electric wires is wound around one or more other electric wires at interval in a length direction, and a wound portion is brazed with the brazing material.

3. The electric motor for a compressor according to claim 2, wherein the residue of the flux adheres to a position corresponding to the interval on the surface of the brazing material in the joint portion of the plurality of electric wires.

4. The electric motor for a compressor according to claim 2, wherein the one electric wire is the aluminum wire and the one or more other electric wires are copper wires.

5. The electric motor for a compressor according to claim 4, wherein the copper wires are two or more solid wires parallel to one another.

6. The electric motor for a compressor according to claim 4, wherein the copper wires are a solid wire and a stranded wire parallel to one another.

7. The electric motor for a compressor according to claim 1, wherein a melting point of the brazing material is lower by 150° C. or more than any melting points of the plurality of electric wires.

8. The electric motor for a compressor according to claim 1, wherein the melting point of the brazing material is 400° C. or higher.

9. The electric motor for a compressor according to claim 1, wherein the joint portion of the plurality of electric wires and the insulating material are fixed together with varnish.

10. A compressor comprising:
the electric motor for a compressor according to claim 1; and
a compression element to compress a refrigerant by being driven by the electric motor for a compressor.

11. A refrigerating cycle apparatus comprising:
a refrigerant circuit to which the compressor according to claim 10 is connected and in which a refrigerant circulates.

12. A method for manufacturing an electric motor for a compressor, comprising:
a step for joining a plurality of electric wires including an aluminum wire with a brazing material containing a flux; and
a step for covering a joint portion of the plurality of electric wires with an insulating material and bringing an inner surface of the insulating material into contact with a surface of the brazing material in the joint portion of the plurality of electric wires, to which a residue of the flux adheres.

13. The electric motor for a compressor according to claim 1, wherein the brazing material is a Zn—Al based brazing material.

14. The electric motor for a compressor according to claim 1, wherein the flux includes cesium fluoride.
